(19) United States
(12) Patent Application Publication
(10) Pub. No.: US 2026/0081377 A1
(43) Pub. Date: Mar. 19, 2026

(54) TERMINAL UNIT, FEMALE TERMINAL, AND MALE TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuya TSUKAMOTO, Mie (JP); Shun OTSUJI, Mie (JP)

(21) Appl. No.: 19/108,437

(22) PCT Filed: Aug. 30, 2023
(86) PCT No.: PCT/JP2023/031431

§ 371 Date: Mar. 4, 2025

(30) Foreign Application Priority Data
Sep. 6, 2022 (JP) 2022-141378

(51) Int. Cl. H01R 13/04; H01R 13/187; H01R 13/24; H01R 43/04

(52) U.S. Cl. CPC H01R 13/04; H01R 13/187; H01R 13/2492; H01R 43/04

(57) ABSTRACT

A terminal unit includes a male terminal and a female terminal. The female terminal includes a first contact portion and a second contact portion. The male terminal includes a pair of inclined portions. The first contact portion includes a pair of first inclined side edge parts. The second contact portion includes a pair of second inclined side edge parts. A contact point forming fitting formed by a separate thin metal plate is conductively fixed to the pair of first inclined side edge parts or the pair of second inclined side edge parts. The contact point forming fitting includes a pair of first contact point portions. The first contact point portions are respectively pressed into contact with the inclined portions and the inclined portions are respectively sandwiched between the pair of first inclined side edge parts and the pair of second inclined side edge parts.

### TECHNICAL FIELD

The present disclosure relates to a terminal unit and a female terminal, and a male terminal used in the terminal unit.

### BACKGROUND

Patent Document 1 discloses a terminal unit composed of a plate-like male terminal represented to have a tab shape and a female terminal to be connected to the male terminal. The female terminal includes a pair of wall portions arranged to face each other across a male terminal insertion gap, one wall portion is provided with a resilient contact piece for pressing the male terminal against the other wall portion and a plurality of contact points project on the other wall portion.

### Prior Art Document

### Patent Document

Patent Document 1: JP 2017-204396 A

### SUMMARY OF THE INVENTION

### Problems to be Solved

Since the terminal unit of Patent Document 1 is structured to sandwich the flat plate-like male terminal between the pair of wall portions of the female terminal, a gripping force against an external force in a plate width direction of the male terminal is small. Thus, it is thought that slight sliding friction between the male and female terminals is created by vibration or the like and a contact resistance value is increased. Therefore, a further improvement of the terminal unit has been required.

Accordingly, a terminal unit and a female terminal and a male terminal used in the terminal unit are disclosed which can suppress an increase of a contact resistance value due to slight sliding friction between the male and female terminals by suppressing a displacement of the male terminal in a plate width direction with respect to the female terminal.

### Means to Solve the Problem

A terminal unit of the present disclosure is provided with a plate-like male terminal and a female terminal to be connected to the male terminal, the female terminal including a first contact portion and a second contact portion arranged to face each other across a male terminal press-fit gap, the male terminal being press-fit and arranged in the male terminal press-fit gap, the male terminal including a pair of inclined portions inclined toward one side in a plate thickness direction of the male terminal on both sides in a plate width direction intersecting a press-fitting direction into the male terminal press-fit gap, the first contact portion of the female terminal including a pair of first inclined side edge parts facing a surface of the male terminal on the one side in the plate thickness direction and respectively inclined along the pair of inclined portions of the male terminal and the second contact portion of the female terminal including a pair of second inclined side edge parts facing a surface of the male terminal on the other side in the plate thickness direction and respectively inclined along the pair of inclined portions of the male terminal, a contact point forming fitting thinner than the first inclined side edge parts and the second inclined side edge parts and formed by an easily deflected and deformed and separate thin metal plate being conductively fixed to at least either the pair of first inclined side edge parts or the pair of second inclined side edge parts, the contact point forming fitting including a pair of first contact point portions projecting toward the male terminal press-fit gap, and the pair of first contact point portions being respectively pressed into contact with the pair of inclined portions of the male terminal and the pair of inclined portions of the male terminal being respectively sandwiched between the pair of first inclined side edge parts and the pair of second inclined side edge parts of the female terminal by resilient restoring forces of the pair of first contact point portions of the female terminal with the male terminal allowed to be press-fit into the male terminal press-fit gap by deflection and deformation of the pair of first contact point portions and the male terminal press-fit in the male terminal press-fit gap.

A female terminal of the present disclosure is a female terminal to be used in the terminal unit of the present disclosure.

A male terminal of the present disclosure is a male terminal to be used in the terminal unit of the present disclosure.

### Effect of the Invention

According to the present disclosure, it is possible to provide a terminal unit and a female terminal, and a male terminal used in the terminal unit, which can suppress an increase of a contact resistance value due to slight sliding friction between the male and female terminals by suppressing a displacement of the male terminal in a plate width direction with respect to the female terminal.

### BRIEF DESCRIPTION OF THE DRAWINGS

FIG. 1 is a perspective view showing a terminal unit according to a first embodiment in a connected state of a male terminal and a female terminal.

FIG. 2 is a plan view of the terminal unit shown in FIG. 1.

FIG. 3 is a longitudinal section along III-III in FIG. 4 of the terminal unit shown in FIG. 1.

FIG. 4 is a transverse section enlargedly showing a cross-section along IV-IV in FIG. 2.

FIG. 5 is a section along V-V in FIG. 4.

FIG. 6 is a perspective view showing the female terminal constituting the terminal unit shown in FIG. 1 in a state not connected to the male terminal.

FIG. 7 is a longitudinal section, corresponding to FIG. 5, of the female terminal shown in FIG. 6 together with the male terminal.

FIG. 8 is a perspective view showing the female terminal shown in FIG. 6 in a developed state before being bent.

FIG. 9 is a perspective view showing a contact point forming fitting constituting the female terminal shown in FIG. 6.

FIG. 10 is a perspective view showing a terminal unit according to a second embodiment in a connected state of a male terminal and a female terminal.

FIG. 11 is a plan view of the terminal unit shown in FIG. 10.

FIG. 12 is a section along XII-XII in FIG. 11.

FIG. 13 is a perspective view showing a female terminal body constituting the female terminal shown in FIG. 10 in a developed state before being bent.

FIG. 14 is a perspective view showing a contact point forming fitting constituting the female terminal shown in FIG. 10.

### DETAILED DESCRIPTION TO EXECUTE THE INVENTION

### Description of Embodiments of Present Disclosure

First, embodiments of the present disclosure are listed and described.

(1) The terminal unit of the present disclosure is provided with a plate-like male terminal and a female terminal to be connected to the male terminal, the female terminal including a first contact portion and a second contact portion arranged to face each other across a male terminal press-fit gap, the male terminal being press-fit and arranged in the male terminal press-fit gap, the male terminal including a pair of inclined portions inclined toward one side in a plate thickness direction of the male terminal on both sides in a plate width direction intersecting a press-fitting direction into the male terminal press-fit gap, the first contact portion of the female terminal including a pair of first inclined side edge parts facing a surface of the male terminal on the one side in the plate thickness direction and respectively inclined along the pair of inclined portions of the male terminal and the second contact portion of the female terminal including a pair of second inclined side edge parts facing a surface of the male terminal on the other side in the plate thickness direction and respectively inclined along the pair of inclined portions of the male terminal, a contact point forming fitting thinner than the first inclined side edge parts and the second inclined side edge parts and formed by an easily deflected and deformed and separate thin metal plate being conductively fixed to at least either the pair of first inclined side edge parts or the pair of second inclined side edge parts, the contact point forming fitting including a pair of first contact point portions projecting toward the male terminal press-fit gap, and the pair of first contact point portions being respectively pressed into contact with the pair of inclined portions of the male terminal and the pair of inclined portions of the male terminal being respectively sandwiched between the pair of first inclined side edge parts and the pair of second inclined side edge parts by resilient restoring forces of the pair of first contact point portions of the female terminal with the male terminal allowed to be press-fit into the male terminal press-fit gap by deflection and deformation of the pair of first contact point portions and the male terminal press-fit in the male terminal press-fit gap.

According to the terminal unit of the present disclosure, the female terminal includes the first and second contact portions arranged to face each other across the male terminal press-fit gap and is structured to sandwich the male terminal press-fit into the male terminal press-fit gap between the first and second contact portions. The male terminal includes the pair of inclined portions inclined toward the one side in the plate thickness direction of the male terminal on the both sides in the plate width direction of the male terminal, which is a direction intersecting the press-fitting direction into the male terminal press-fit gap. Similarly, the first contact portion of the female terminal includes the pair of first inclined side edge parts facing the surface of the male terminal on the one side in the plate thickness direction and respectively inclined along the pair of inclined portions of the male terminal, and the second contact portion of the female terminal includes the pair of second inclined side edge parts facing the surface of the male terminal on the other side in the plate thickness direction and respectively inclined along the pair of inclined portions of the male terminal. Further, the contact point forming fitting thinner than the first inclined side edge parts and the second inclined side edge parts and formed by the easily deflected and deformed and separate thin metal plate is fixed to at least either the pair of first inclined side edge parts or the pair of second inclined side edge parts. The contact point forming fitting includes the pair of first contact point portions projecting toward the male terminal press-fit gap. Thus, the pair of first contact point portions can be respectively pressed into contact with the pair of inclined portions of the male terminal and the pair of inclined portions of the male terminal can be respectively sandwiched between the pair of first inclined side edge parts and the pair of second inclined side edge parts of the female terminal by the resilient restoring forces of the pair of first contact point portions of the female terminal with the male terminal allowed to be press-fit into the male terminal press-fit gap by the deflection and deformation of the pair of first contact point portions and the male terminal press-fit in the male terminal press-fit gap.

In this way, if an external force is exerted in the plate width direction of the male terminal, the inclined portions of the male terminal are pressed by the similarly inclined first inclined side edge parts and second inclined side edge parts of the female terminal on the both sides in the plate width direction of the male terminal and components of force (reaction forces from the first inclined side edge parts and the second inclined side edge parts) acting inward in the plate width direction are generated. As a result, a force for hindering a displacement of the male terminal can be increased against the external force acting outward in the plate width direction of the male terminal as compared to the conventional structure, and a displacement of the male terminal in the plate width direction with respect to the female terminal can be suppressed.

Moreover, since at least either the pair of first inclined side edge parts or the pair of second inclined side edge parts are provided with the pair of first contact point portions formed by the contact point forming fitting thinner than the first inclined side edge parts and the second inclined side edge parts and formed by the easily deflected and deformed and separate thin metal plate, the male terminal can be easily press-fit into the male terminal press-fit gap by the deflection and deformation of the pair of first contact point portions and an insertion force can be reduced. Further, the pair of inclined portions of the male terminal press-fit in the male terminal press-fit gap can be respectively held sandwiched between the pair of first inclined side edge parts and the pair of second inclined side edge parts of the female terminal by the resilient restoring forces of the pair of first contact point portions. Therefore, a contact pressure between the male and female terminals can be ensured and a connected state of the male and female terminals can be advantageously held without requiring a separate clip spring for biasing the first and second contact portions in approaching directions. Particularly, since the pair of first contact point portions are configured using the contact point forming fitting thinner than the first inclined side edge parts and the second inclined side edge parts of the female terminal and formed by the easily deflected and deformed and separate thin metal plate, a contact area of the first contact point portions with the male terminal can be increased and the followability of the first contact point portions to a displacement of the male terminal can also be improved as compared to the case where the first contact point portions are directly provided on the pair of first inclined side edge parts and the pair of second inclined side edge parts. Moreover, since the first contact point portions can be provided by the separate contact point forming fitting, a degree of freedom in designing the first contact point portions can be improved and a plurality of contact points matching use conditions can be easily provided at optimal positions to have an optimal shape.

Here, concerning the pair of first inclined side edge parts and the pair of second inclined side edge parts “respectively inclined along the pair of inclined portions of the male terminal”, the first and second inclined side edge parts only have to be inclined along the inclined portions of the male terminals and may not necessarily be parallel to the inclined portions of the male terminal. For example, an angle of inclination of the first/second inclined side edge parts may be different from that of the inclined portions of the male terminal within a range of about 0 to 10°.

Further, the pair of first contact point portions may be provided on either the pair of first inclined side edge parts or the pair of second inclined side edge parts or may be provided on both. An arbitrary shape can be adopted as the shape of each first contact point portion if the first contact point portion is shaped to be deflected and deformed toward the outside of the male terminal press-fit gap by being pressed by the male terminal press-fit into the male terminal press-fit gap and resiliently return toward the inside of the male terminal press-fit gap.

(2) Preferably, in (1) described above, the female terminal includes a coupling plate portion for conductively coupling the first and second contact portions and the second contact portion includes an external connecting portion, the contact point forming fitting is fixed to the pair of first inclined side edge parts of the first contact portion of the female terminal, a pair of second contact point portions formed by the respective second inclined side edge parts partially projecting toward the male terminal press-fit gap are provided on the pair of second inclined side edge parts of the second contact portion of the female terminal, and the pair of inclined portions of the male terminal are pressed into contact with the pair of second contact point portions of the female terminal by resilient restoring forces of the first contact point portions with the male terminal press-fit in the male terminal press-fit gap.

The second contact portion of the female terminal is provided with the external connecting portion, to which a wire end or a circuit end outside is connected, and the second contact point portions formed by causing parts of the second contact portion to partially project. The pair of inclined portions of the male terminal can be pressed into contact with such second contact point portions by the resilient restoring forces of the first contact point portions, and it is possible both to ensure a contact pressure of the male and female terminals and to reduce contact resistance between the male and female terminals by a small number of components.

(3) Preferably, in (1) or (2) described above, the contact point forming fitting includes a welding fixing portion to be fixed to at least either the pair of first inclined side edge parts or the pair of second inclined side edge parts by welding. The contact point forming fitting is fixed to the respective first inclined side edge parts and/or the respective second inclined side edge parts at the welding fixing portion by welding. In this way, a reduction in conduction resistance of the first contact point portions of the contact point forming fitting with the respective first inclined side edge parts and/or the respective second inclined side edge parts and a stable fixed state can be advantageously realized.

(4) Preferably, in (3) described above, the contact point forming fitting of the female terminal has a strip shape extending in the press-fitting direction of the male terminal into the male terminal press-fit gap, the contact point forming fitting includes the welding fixing portion provided in a central part in a longitudinal direction and a forward projecting tongue piece and a rearward projecting tongue piece cantilevered toward both ends in the longitudinal direction from the welding fixing portion, and the forward projecting tongue piece and the rearward projecting tongue piece extend in the longitudinal direction while having a curved shape convex toward the male terminal press-fit gap in a side view and the first contact point portion is provided in an intermediate part in the longitudinal direction of each of the forward projecting tongue piece and the rearward projecting tongue piece.

The contact point forming fitting has the strip shape extending in the press-fitting direction of the male terminal, and the welding fixing portion is provided in the central part in the longitudinal direction of the contact point forming fitting. The forward projecting tongue piece and the rearward projecting tongue piece can be cantilevered toward the both ends in the longitudinal direction (press-fitting direction of the male terminal) from the welding fixing portion, and the first contact point portions are respectively provided on the forward projecting tongue piece and the rearward projecting tongue piece. Therefore, the followability of the first contact point portions to a displacement of the male terminal in a front-rear direction (press-fitting direction) can be advantageously improved.

Moreover, the forward projecting tongue piece and the rearward projecting tongue piece extend in the longitudinal direction while having the curved shape convex toward the male terminal press-fit gap in the side view, and the first contact point portion is provided in the intermediate part in the longitudinal direction of each of the forward projecting tongue piece and the rearward projecting tongue piece. In this way, a deflection deformation amount of the first contact point portion can be advantageously ensured, and it is possible to further improve followability to the deformation of the male terminal and increase the contact area. Particularly, a projection amount of a projecting end part of the rear projecting tongue piece into the male terminal press-fit gap is less than that of the first contact portion due to the curved shape of the rearward projecting tongue piece, and a function for guiding the male terminal toward the press-fit gap can also be exhibited while a risk of collision with the male terminal during the insertion of the male terminal is reduced.

(5) Preferably, in any one of (1) to (4) described above, the contact point forming fitting includes a crimp fixing portion to be fixed to at least either the pair of first inclined side edge parts or the pair of second inclined side edge parts by crimping. The contact point forming fitting is fixed to the respective first inclined side edge parts and/or the respective second inclined side edge parts at the crimp fixing portion by crimping. In this way, the contact point forming fitting can be easily fixed while ensuring the conductivity of the first contact point portions of the contact point forming fitting with the respective first inclined side edge parts and/or the respective second inclined side edge parts.

(6) Preferably, in (5) described above, the contact point forming fitting of the female terminal has a strip shape extending in the press-fitting direction of the male terminal into the male terminal press-fit gap, the contact point forming fitting includes the crimp fixing portion provided in a central part in a longitudinal direction and a forward projecting tongue piece and a rearward projecting tongue piece cantilevered toward both ends in the longitudinal direction from the crimp fixing portion, and the forward projecting tongue piece and the rearward projecting tongue piece extend in the longitudinal direction while having a curved shape convex toward the male terminal press-fit gap in a side view and the first contact point portion is provided in an intermediate part in the longitudinal direction of each of the forward projecting tongue piece and the rearward projecting tongue piece.

The contact point forming fitting has the strip shape extending in the press-fitting direction of the male terminal, and the crimp fixing portion is provided in the central part in the longitudinal direction of the contact point forming fitting. The forward projecting tongue piece and the rearward projecting tongue piece can be cantilevered toward the both sides in the longitudinal direction (press-fitting direction of the male terminal) from the crimp fixing portion, and the first contact point portions are respectively provided on the forward projecting tongue piece and the rearward projecting tongue piece. Therefore, the followability of the first contact point portions to a displacement of the male terminal in the front-rear direction (press-fitting direction) can be advantageously improved.

Moreover, the forward projecting tongue piece and the rearward projecting tongue piece extend in the longitudinal direction while having the curved shape convex toward the male terminal press-fit gap in the side view, and the first contact point portion is provided in the intermediate part in the longitudinal direction of each of the forward projecting tongue piece and the rearward projecting tongue piece. In this way, a deflection deformation amount of the first contact point portion can be advantageously ensured, and it is possible to further improve followability to the deformation of the male terminal and increase the contact area. Particularly, a projection amount of a projecting end part of the rear projecting tongue piece into the male terminal press-fit gap is less than that of the first contact portion due to the curved shape of the rearward projecting tongue piece, and a function for guiding the male terminal toward the press-fit gap can also be exhibited while a risk of collision with the male terminal during the insertion of the male terminal is reduced.

(7) In any one of (1) to (6) described above, the male terminal includes a central flat portion arranged between the pair of inclined portions in the plate width direction, the first contact portion of the female terminal includes a first flat portion arranged between the pair of first inclined side edge parts in the plate width direction and spreading to face along the central flat portion of the male terminal, and the second contact portion of the female terminal includes a second flat portion arranged between the pair of second inclined side edge parts in the plate width direction and spreading to face along the central flat portion of the male terminal.

The male terminal includes the central flat portion and the pair of inclined portions inclined toward the same side in the plate thickness direction on both sides of the central flat portion, and the first and second contact portions of the female terminal are arranged on the both sides in the plate thickness direction of the male terminal, and shaped similarly to the male terminal. That is, the first contact portion includes the first flat portion spreading along the central flat portion of the male terminal and the first inclined side edge parts arranged on the both sides of the first flat portion and inclined along the pair of inclined portions of the male terminal, and the second contact portion includes the second flat portion spreading along the central flat portion of the male terminal and the second inclined side edge parts arranged on the both sides of the second flat portion and inclined along the pair of inclined portions of the male terminal. Since the male terminal and the first/second contact portion of the female terminal have similar shapes to each other and are arranged to face each other, a useless gap is not formed in the terminal unit itself and the terminal unit can be reduced in size.

(8) The female terminal of the present disclosure is used in the terminal unit of any one of (1) to (7) described above.

According to the female terminal of the present disclosure, effects of any one of (1) to (7) described above can be achieved by connecting a male terminal to the female terminal to configure the terminal unit.

(9) The male terminal of the present disclosure is used in the terminal unit of any one of (1) to (7) described above.

According to the male terminal of the present disclosure, effects of any one of (1) to (7) described above can be achieved by connecting the male terminal to a female terminal to configure the terminal unit.

### details of Embodiments of Present Disclosure

Specific examples of a terminal unit of the present disclosure and a female terminal and a male terminal used in the terminal unit are described below with reference to the drawings. Note that the present disclosure is not limited to these illustrations, but is represented by claims and intended to include all changes in the scope of claims and in the meaning and scope of equivalents.

### First Embodiment

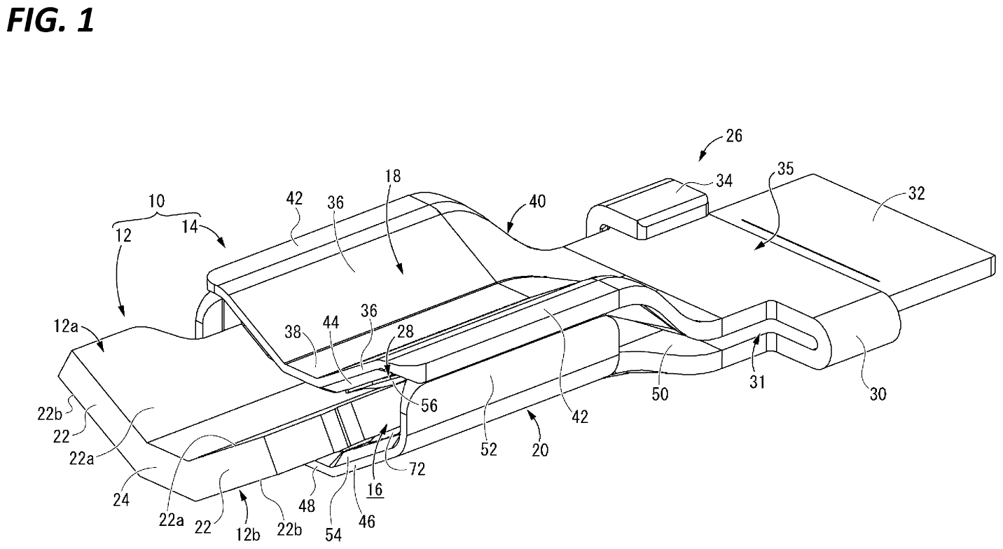

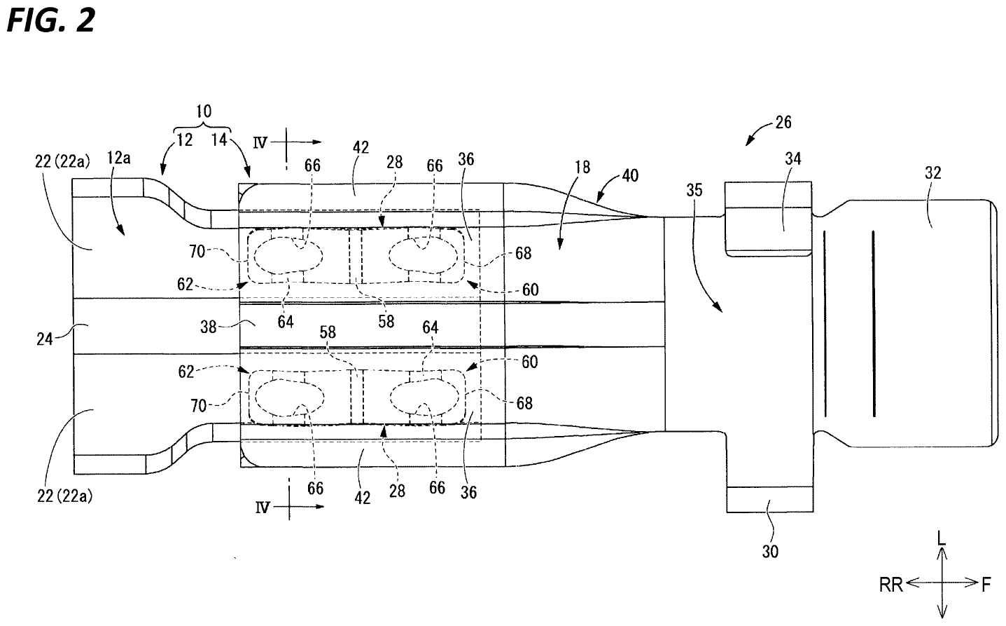

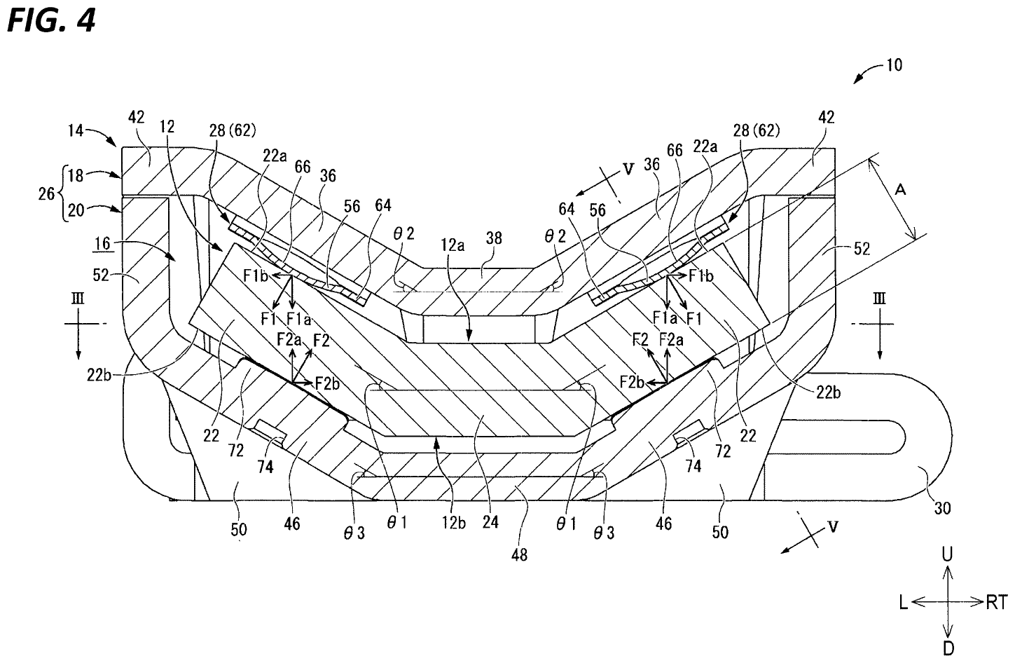

Hereinafter, a terminal unit 10 of a first embodiment of the present disclosure is described using FIGS. 1 to 9. The terminal unit 10 is provided with a plate-like male terminal 12 and a female terminal 14 to be connected to the male terminal 2. The female terminal 14 includes a first contact portion 18 and a second contact portion 20 arranged to face each other across a male terminal press-fit gap 16, into which the male terminal 12 is press-fit and arranged. The male terminal 12 is press-fit and inserted into the male terminal press-fit gap 16 in the female terminal 14 and contacts the first and second contact portions 18, 20, whereby the male terminal 12 and the female terminal 14 are electrically connected. Note that the terminal unit 10 can be arranged in an arbitrary orientation, but upper and lower sides in FIG. 4 are referred to as upper and lower sides, upper and lower sides in FIG. 2 are referred to as left and right sides, and right and left sides in FIG. 2 are referred to as front and rear sides in the following description. Further, for a plurality of identical members, only some members may be denoted by a reference sign and the other members may not be denoted by the reference sign.

### Male Terminal 12

The male terminal 12 is plate-like as a whole and configured using an unillustrated flat plate fitting. The flat plate fitting has a substantially rectangular shape as a whole, has predetermined plate width and plate thickness, and extends straight. Note that the male terminal 12 is press-fit into the male terminal press-fit gap 16 in the female terminal 14 from rear to front, and a part (front part) of the male terminal 12 to be press-fit into the male terminal press-fit gap 16 has a tapered shape as compared to a rear part (see FIGS. 1 and 2 and the like). The male terminal 12 is electrically conductive and made of metal having a low electrical resistance such as copper, copper alloy, aluminum or aluminum alloy.

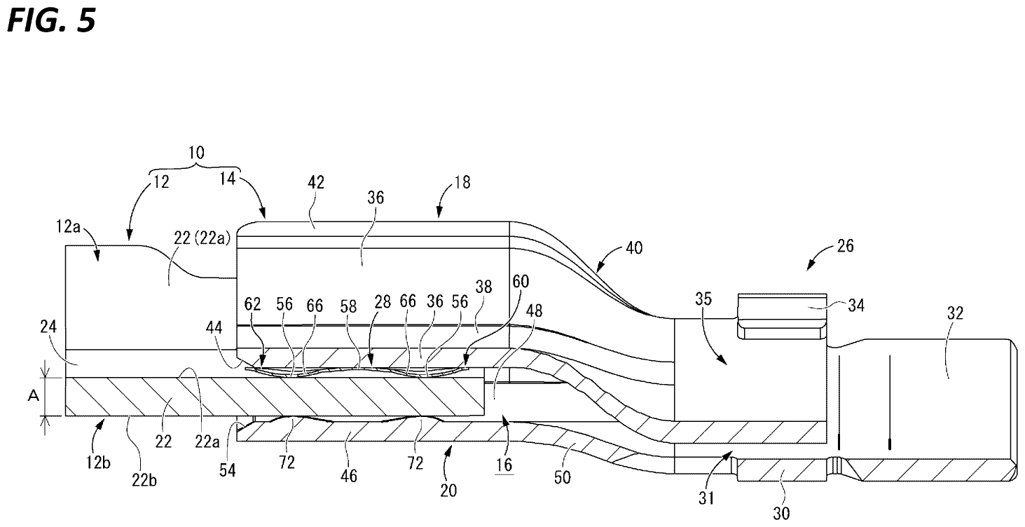

Both end parts in the plate width direction (lateral direction) of the flat plate fitting are bent and inclined toward one side (upper side) in the plate thickness direction, whereby a pair of inclined portions 22, 22 are provided in the both end parts in the plate width direction of the male terminal 12. That is, in the male terminal 12, the pair of inclined portions 22, 22 are provided on the both sides in the plate width direction, which is a direction intersecting, in the first embodiment, orthogonal to a press-fitting direction (direction from rear to front) into the male terminal press-fit gap 16. A central flat portion 24 spreading flat is provided in a central part in the plate width direction located between the pair of inclined portions 22, 22 in the plate width direction of the male terminal 12. Note that the pair of inclined portions 22, 22 may be provided over the entire length of the male terminal 12 or may be provided only in a part (front part having the tapered shape) of the male terminal 12 to be press-fit into the male terminal press-fit gap 16. In the first embodiment, the plate thickness of the male terminal 12 is substantially constant and a thickness of each of the pair of inclined portions 22, 22 and the central flat portion 24 is A (see FIGS. 4 and 5), but the thicknesses of the pair of inclined portions 22, 22 and the central flat portion 24 may be different from each other.

An angle of inclination of the pair of inclined portions 22, 22 to the central flat portion 24 is θ1 (see FIG. 4). Note that the angle of inclination of the inclined portion 22 on one side (left side) in the plate width direction and that of the inclined portion 22 on the other side (right side) in the plate width direction are equal (θ1) in the male terminal 12 in the first embodiment, but the angles of inclination on both left and right sides may be different from each other.

The angle of inclination θ1 of the pair of inclined portions 22, 22 to the central flat portion 24 is not limited, but is preferably, for example, 5° or more and 45° or less, more preferably 10° or more and 30° or less. By setting the angle of inclination θ1 of the inclined portions 22 to 5° or more, a displacement of the male terminal 12 in the plate width direction can be suppressed also when an outward external force in the plate width direction is input to the male terminal 12. By setting the angle of inclination θ1 of the inclined portions to 45°or less, vertical dimensions of the male terminal 12 and, consequently, the terminal unit 10 can be suppressed to be small.

In the male terminal 12, a rear side part behind the front part having the tapered shape extends straight. For example, this rear side part may extend rearward in a state shown in FIG. 1 with the pair of inclined portions 22, 22 provided or may have a substantially flat plate shape extending rearward without the pair of inclined portions 22, 22 being provided. The rear side part in the male terminal 12 is, for example, fixed to a wire by crimping, welding or the like or provided with a bolt insertion hole and fixed to a terminal portion of a device.

### Female Terminal 14

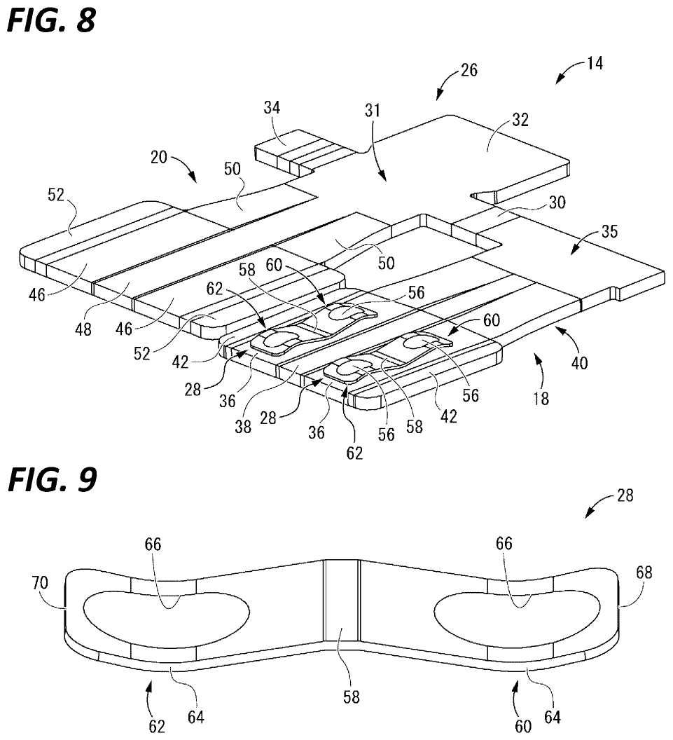

The female terminal 14 is, as also shown in FIG. 8, configured to include a female terminal body 26 constituted by one flat metal plate and a pair of contact point forming fittings 28, 28 to be fixed to the female terminal body 26, and the female terminal 14 is formed by bending the female terminal body 26 having each contact point forming fitting 28 fixed thereto into a predetermined shape described below. That is, the female terminal body 26 includes the first and second contact portions 18, 20 defining the male terminal press-fit gap 16 and also includes a coupling plate portion 30 conductively coupling the first and second contact portions 18, 20. Further, the female terminal body 26 includes an external connecting portion 32, to which a core wire of an unillustrated wire is fixed or a busbar or the like constituting an internal circuit of an unillustrated device or the like is coupled. In the first embodiment, the external connecting portion 32 is provided in a front end part 31 of the second contact portion 20.

The front end part 31 of the second contact portion 20 is formed with a crimp piece 34, and displacements (separating displacements) of the first and second contact portions 18, 20 in opening directions are prevented in the female terminal body 26 bent into the predetermined shape by this crimp piece 34. Note that such a female terminal body 26 is electrically conductive and can be formed using one of various metal materials capable of being press-worked or stamped such as brass, copper, copper alloy, aluminum and aluminum alloy. In the first embodiment, the female terminal body 26 is made of pure copper excellent in electrical conductivity.

Specifically, as shown in FIG. 8, the first and second contact portions 18, 20 before being bent respectively have a substantially rectangular shape in a plan view, are arranged side by side in the plate width direction (lateral direction), and a front end part 35 of the first contact portion 18 and the front end part 31 of the second contact portion 20 are coupled by the coupling plate portion 30. Further, the crimp piece 34 is provided to project on a side (left side) opposite to a side where the coupling plate portion 30 is provided in the front end part 31 of the second contact portion 20. By bending the coupling plate portion 30 such that the first and second contact portions 18, 20 face each other in a vertical direction and fixing the first and second contact portions 18, 20 by the crimp piece 34, the female terminal body 26 is maintained in the predetermined bent shape. In other words, one end sides (front end parts 35, 31) in the longitudinal direction of the first and second contact portions 18, 20 are coupled by the coupling plate portion 30 in the female terminal 14, and the first and second contact portions 18, 20 are respectively cantilevered rearward from the respective coupled front end parts 35, 31. Further, the front end part in the second contact portion 20 extends further forward than the coupled part to the first contact portion 18 and constitutes the external connecting portion 32 substantially in the form of a rectangular flat plate.

### First Contact Portion 18

The first contact portion 18 before being bent is substantially in the form of a rectangular flat plate as a whole and extends substantially straight in a front-rear direction. The shape of the first contact portion 18 after bending is described below. The first contact portion 18 includes a pair of first inclined side edge parts 36, 36 respectively facing a surface (upper surface 12a) of the male terminal 12 on one side in the plate thickness direction of the male terminal 12 and inclined along the pair of inclined portions 22, 22 of the male terminal 12. These first inclined side edge parts 36 are formed by bending both end parts in the plate width direction (lateral direction) of the first contact portion 18 toward the one side (upper side) in the plate thickness direction with respect to a central part in the plate width direction. The first contact portion 18 is provided with a first flat portion 38 facing the central flat portion 24 in the male terminal 12 and spreading flat along the central flat portion 24 between the pair of first inclined side edge parts 36, 36 in the plate width direction.

In the first embodiment, each first inclined side edge part 36 is provided over a predetermined length from the rear end of the first contact portion 18. Each first inclined side edge part 36 is inclined at a predetermined angle of inclination θ2 (see FIG. 4) with respect to the first flat portion 38 in a rear end part of the first contact portion 18. Note that the angle of inclination of the first inclined side edge part 36 on one side (left side) in the plate width direction to the first flat portion 38 and that of the first inclined side edge part 36 on the other side (right side) in the plate width direction to the first flat portion 38 are equal (θ2) in the first embodiment, but the angles of inclination on the both left and right sides may be different from each other.

Further, the front end part 35 of the first contact portion 18 is located below the first flat portion 38 provided in the rear part of the first contact portion 18, and a transition portion 40 changing while being curved gradually downward toward the front is provided in an intermediate part in the front-rear direction in the first contact portion 18. Note that the respective first inclined side edge parts 36 are not provided on both end parts in the lateral direction in the front end part 35 of the first contact portion 18, and the front end part 35 in the first contact portion 18 spreads substantially in parallel to the first flat portion 38. That is, angles of inclination of the both end parts in the lateral direction in the front end part 35 to a lateral central part are 0, and both end parts in the lateral direction of the transition portion 40 do not only change downward toward the front, but also the angles of inclination to the lateral central part are gradually reduced from θ2 to 0.

Note that, in the first contact portion 18, first end edge parts 42, 42 spreading substantially in parallel to the first flat portion 38 are provided on outer end parts in the lateral direction of the respective first inclined side edge parts 36 (i.e. end parts opposite to the sides connected to the first flat portion 38 in the lateral direction). Each first end edge part 42 is provided over an entire length in a longitudinal direction (front-rear direction) of each first inclined side edge part 36 and spreads in a horizontal direction (direction orthogonal to the vertical direction).

Further, as also shown in FIGS. 5 to 7, a guiding surface 44 gradually separating from the second contact portion 20 facing the first contact portion 18 in the vertical direction toward the rear side, i.e. gradually approaching the male terminal press-fit gap 16 on the inner side toward the front, is provided on the inner surface of the rear end part of the first contact portion 18. Similarly, a guiding surface 54 is provided on the inner surface of a rear end part of the second contact portion 20 as described later, and the male terminal 12 is guided into the male terminal press-fit gap 16 in the female terminal 14 by these guiding surfaces 44, 54 when the male terminal 12 is press-fit into the female terminal 14. Such guiding surfaces 44, 54 are, for example, formed by press working or the like in a developed state of the female terminal body 26 shown in FIG. 8. Therefore, the guiding surface 44 is provided substantially over the entire length in the lateral direction of the first contact portion 18, i.e. over the respective first end edge parts 42 and the respective first inclined side edge parts 36 on the both left and right sides and the first flat portion 38.

### Second Contact Portion 20

The second contact portion 20 before being bent is substantially in the form of a rectangular flat plate as a whole and extends substantially straight in the front-rear direction. The shape of the second contact portion 20 after bending is described below. The second contact portion 20 includes a pair of second inclined side edge parts 46, 46 respectively facing a surface (lower surface 12b) of the male terminal 12 on the other side in the plate thickness direction and inclined along the pair of inclined portions 22, 22 of the male terminal 12. These respective second inclined side edge parts 46 are formed by bending both end parts in the plate width direction (lateral direction) of the second contact portion 20 toward the one side (upper side) in the plate thickness direction with respect to a central part in the plate width direction. The second contact portion 20 is provided with a second flat portion 48 facing the central flat portion 24 in the male terminal 12 and spreading flat along the central flat portion 24 between the pair of second inclined side edge parts 46, 46 in the plate width direction.

In the first embodiment, each second inclined side edge part 46 is provided over a predetermined length from the rear end of the second contact portion 20. Each second inclined side edge part 46 is inclined at a predetermined angle of inclination θ3 (see FIG. 4) with respect to the second flat portion 48 in the rear end part of the second contact portion 20. Note that the angle of inclination of the second inclined side edge part 46 on the one side (left side) in the plate width direction to the second flat portion 48 and that of the second inclined side edge part 46 on the other side (right side) in the plate width direction to the second flat portion 48 are equal (θ3) in the first embodiment, but the angles of inclination on the both left and right sides may be different from each other.

Preferably, the angle of inclination θ2 of each first inclined side edge part 36 to the first flat portion 38 is equal to the angle of inclination θ1 of each inclined portion 22 to the central flat portion 24 in the male terminal 12 or an angle difference is within 10° even if these angles are different. Similarly, preferably, the angle of inclination 03 of each second inclined side edge part 46 to the second flat portion 48 is equal to the angle of inclination θ1 of each inclined portion 22 to the central flat portion 24 in the male terminal 12 or an angle difference is within 10° even if these angles are different. In this way, the rattling of the male terminal 12 in the male terminal press-fit gap 16 can be suppressed when the male terminal 12 is press-fit into the male terminal press-fit gap 16.

In the first embodiment, the angle of inclination θ2 of each first inclined side edge part 36 to the first flat portion 38 and the angle of inclination θ3 of each second inclined side edge part 46 to the second flat portion 48 are set to be substantially equal. Therefore, in the first embodiment, the first and second inclined side edge parts 36, 46 on the left side spread substantially in parallel and the first and second inclined side edge parts 36, 46 on the right side spread substantially in parallel.

The front end part 31 of the second contact portion 20 is located substantially at the same position in the vertical direction as the second flat portion 48 of the second contact portion 20, and transition portions 50, 50 changing only in angle of inclination to the second flat portion 48 (front end part 31) are provided on both end parts in the lateral direction in an intermediate part in the front-rear direction of the second contact portion 20. That is, each transition portion 50 in the second contact portion 20 is formed such that the angle of inclination to a lateral central part becomes gradually smaller from θ3 to 0 toward the front.

Note that, in the second contact portion 20, second end edge parts 52, 52 bent upward are provided on outer end parts in the lateral direction of the respective second inclined side edge parts 46 (i.e. end parts opposite to the sides connected to the second flat portion 48 in the lateral direction). Each second end edge part 52 is provided over an entire length in a longitudinal direction (front-rear direction) of each second inclined side edge part 46 and spreads in the vertical direction. As also shown in FIG. 1 and the like, the respective first end edge parts 42 and the respective second end edge parts 52 contact each other in the vertical direction or face each other across a slight separation distance when the female terminal body 26 is bent.

Further, as also shown in FIGS. 5 to 7, the guiding surface 54 gradually separating from the first contact portion 18 facing the second contact portion 20 in the vertical direction toward the rear side, i.e. gradually approaching the male terminal press-fit gap 16 on the inner side toward the front is provided on the inner surface of the rear end part of the second contact portion 20. As described above, since the guiding surface 54 is, for example, formed by press working or the like in the developed state of the female terminal body 26 shown in FIG. 8, the guiding surface 54 is provided substantially over the entire length in the lateral direction of the second contact portion 20, i.e. over the respective second end edge parts 52 and the respective second inclined side edge parts 46 on the both left and right sides and the second flat portion 48.

### Contact Point Forming Fittings 28

The pair of contact point forming fittings 28, 28 are respectively conductively fixed to at least either the pair of first inclined side edge parts 36, 36 or the pair of second inclined side edge parts 46, 46 on the inner surface of the male terminal press-fit gap 16. The respective contact point forming fittings 28 are formed by thin metal plates separate from the respective first inclined side edge parts 36 and the respective second inclined side edge parts 46, and thinner and more easily deformed and deformed (resiliently deformed) than the respective first inclined side edge parts 36 and the respective second inclined side edge parts 46. In the first embodiment, the pair of contact point forming fittings 28, 28 are fixed to the respective inner surfaces of the pair of first inclined side edge parts 36, 36. Each of the pair of contact point forming fittings 28, 28 includes a pair of first contact point portions 56, 56 projecting toward the male terminal press-fit gap 16. Note that since the respective contact point forming fittings 28 have the same shape in the first embodiment, the shape of one contact point forming fitting 28 is described using FIG. 9 and the like.

The contact point forming fitting 28 has a strip shape extending in the front-rear direction, which is the press-fitting direction of the male terminal 12 into the male terminal press-fit gap 16, as a whole. The contact point forming fitting 28 can be made of electrically conductive and springy metal and, in the first embodiment, made of springy copper alloy. Further, in the first embodiment, the contact point forming fitting 28 is fixed to the first inclined side edge part 36 by welding, and a welding fixing portion 58 is provided in a central part in a longitudinal direction (front-rear direction) of the contact point forming fitting 28. The welding fixing portion 58 spreads substantially flat in the contact point forming fitting 28 and is formed substantially over the entire length in a width direction (lateral direction) of the contact point forming fitting 28. Note that a method for welding the contact point forming fitting 28 to the first inclined side edge part 36 is not limited, but laser welding or the like can be, for example, adopted.

### First Contact Point Portion 56

The central flat portion 28 includes a forward projecting tongue piece 60 and rearward projecting tongue piece 62 cantilevered toward both ends in the longitudinal direction (front-rear direction) from the welding fixing portion 58. The forward projecting tongue piece 60 and the rearward projecting tongue piece 62 extend in the front-rear direction while being convexly curved toward the male terminal press-fit gap 16 in a side view. The first contact point portion 56 is provided in an intermediate part in the front-rear direction of each of the forward projecting tongue piece 60 and the rearward projecting tongue piece 62. Specifically, the forward projecting tongue piece 60 has a curved shape convex toward one side in a thickness direction of the contact point forming fitting 28 as a whole and includes a bent portion 64 in the intermediate part in the front-rear direction. That is, the forward projecting tongue piece 60 extends in a direction gradually separating from the welding fixing portion 58 in the thickness direction of the contact point forming fitting 28 toward the front, is bent at the bent portion 64 and extends in a direction gradually approaching the welding fixing portion 58 in the thickness direction of the contact point forming fitting 28 toward the front. The first contact point portion 56 projecting in the same direction as a convex direction (one direction along the thickness direction of the contact point forming fitting 28) of the forward projecting tongue piece 60 is provided in a central part in the width direction (lateral direction) in the forward projecting tongue piece 60.

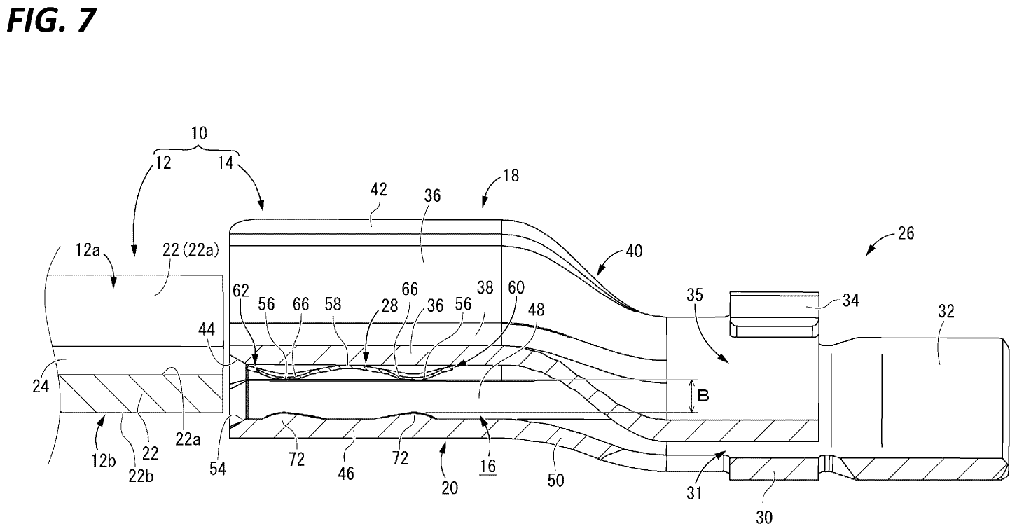

The first contact point portion 56 is formed to have an arcuately curved shape in a longitudinal cross-section of the contact point forming fitting 28 shown in FIG. 7 and formed in a part extending over parts on both sides in the front-rear direction and including the bent portion 64. That is, the first contact point portion 56 has a substantially oval shape having a length (front-rear dimension) larger than a width (lateral dimension) in a plan view (projection in the vertical direction). Such a first contact point portion 56 can be formed, for example, by striking, and a recess 66 is formed at a position corresponding to the first contact point portion 56 in a surface of the forward projecting tongue piece 60 opposite to a surface where the first contact point portion 56 projects.

The rearward projecting tongue piece 62 is shaped similarly to the forward projecting tongue piece 60. That is, the rearward projecting tongue piece 62 has a curved shape convex in the same direction as the forward projecting tongue piece 60 as a whole, and includes a bent portion 64 in the intermediate part in the front-rear direction. The first contact point portion 56 projecting in the same direction as the first contact point portion 56 of the forward projecting tongue piece 60 is provided in a part extending over parts on both front and rear sides and including the bent portion 64 in a central part in the lateral direction of the rearward projecting tongue piece 62. Therefore, the pair of first contact point portions 56, 56 are provided apart from each other in the front-rear direction in the contact point forming fitting 28. Further, a recess 66 is formed at a position corresponding to the first contact point portion 56 on a surface of the rearward projecting tongue piece 62 opposite to a surface where the first contact point portion 56 projects.

The contact point forming fitting 28 shaped as just described is, for example, fixed by laser welding to a part constituting the inner surface of each first inclined side edge part 36 with the welding fixing portion 58 thereof overlapped on this part in the developed state of the female terminal body 26 as shown in FIG. 8. In this state, the forward projecting tongue piece 60 and the rearward projecting tongue piece 62 are curved to be convex upward and the respective first contact point portions 56 project upward. The female terminal body 26 having each contact point forming fitting 28 fixed thereto is bent as described above to configure the female terminal 14, whereby the respective first contact point portions 56 project in a downward direction, specifically in a right lower direction and a left lower direction. Since the respective contact point forming fittings 28 are fixed to the respective first inclined side edge parts 36 separated from each other in the lateral direction in the first embodiment, the first contact portion 18 is provided with a total of four first contact point portions 56 provided apart from each other in the front-rear direction and the lateral direction.

Note that, as also shown in FIG. 7, a front end part 68 of the forward projecting tongue piece 60 and a rear end part 70 of the rearward projecting tongue piece 62 are slightly separated from the inner surface of the first inclined side edge part 36 with each contact point forming fitting 28 fixed to the inner surface of the first inclined side edge part 36, and respectively free ends. As described later, the male terminal 12 is press-fit into the male terminal press-fit gap 16 and upper surfaces 22a of the respective inclined portions 22 of the male terminal 12 contact the respective first contact point portions 56 of the forward projecting tongue pieces 60 and the rearward projecting tongue pieces 62, whereby the forward projecting tongue pieces 60 and the rearward projecting tongue pieces 62 are resiliently deformed in a direction to reduce a projecting dimension of each first contact point portion 56 in the male terminal press-fit gap 16. In this way, the front end parts 68 of the forward projecting tongue pieces 60 and the rear end parts 70 of the rearward projecting tongue pieces 62 are respectively displaced forward and rearward than before being resiliently deformed, and the forward projecting tongue pieces 60 and the rearward projecting tongue pieces 62 are deformed to elongate to increase lengths thereof in the front-rear direction.

Particularly, as shown in FIG. 7, a part of the rearward projecting tongue piece 62 from the first contact point portion 56 to the rear end part 70 is inclined in a direction separating from the facing second inclined side edge part 46 toward the rear side with each contact point forming fitting 28 fixed to the inner surface of the first inclined side edge part 36. In other words, the part of each rearward projecting tongue piece 62 from the rear end part 70 to the first contact point portion 56 gradually approaches the male terminal press-fit gap 16 on the inner side toward the front and a function for guiding the male terminal 12 into the male terminal press-fit gap 16 can be exhibited.

### Second Contact Point Portions 72

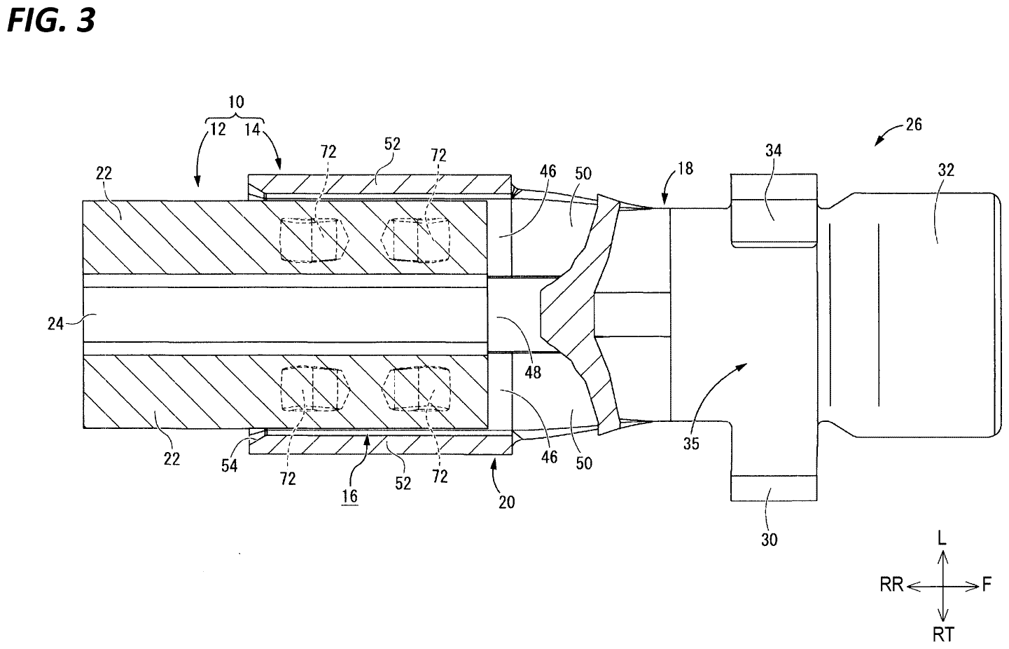

In the first embodiment, a pair of second contact point portions 72, 72 formed to partially project toward the male terminal press-fit gap 16 are provided on the inner surface of each of the pair of second inclined side edge parts 46, 46 in the second contact portion 20 as also shown in FIGS. 3 to 5 and the like. These second contact point portions 72 project in a plate thickness direction of each second inclined side edge part 46 and project in an upward direction, specifically in a right upper direction and a left upper direction. Each second contact point portion 72 is formed to have a larger dimension in the front-rear direction, which is the press-fitting direction of the male terminal 12, than the lateral dimension similarly to each first contact point portion 56, and the projecting tip surface thereof is a curved surface.

Note that the specific shape of each second contact point portion 72 is not limited, but outer parts in the front-rear direction are curved surfaces having a relatively large angle of inclination to the inner surface of the second inclined side edge part 46 and an inner part in the front-rear direction is a curved surface having a relatively small angle of inclination to the inner surface of the second inclined side edge part 46 on the projecting tip surface of each second contact point portion 72 as also shown in FIG. 7 and the like in the first embodiment. Further, in the first embodiment, the respective second contact point portions 72 have the same shape and are provided at two positions separated in the front-rear direction, which is the press-fitting direction of the male terminal 12, on each second inclined side edge part 46. Therefore, the second contact portion 20 is provided with a total of four second contact point portions 72 provided apart from each other in the front-rear direction and the lateral direction.

Particularly, in the first embodiment, the respective second contact point portions 72 are provided at positions corresponding to the respective first contact point portions 56 in the vertical direction, and the respective first contact point portions 56 and the respective second contact point portions 72 overlap each other in projection in the vertical direction as also shown in FIG. 4 and the like. Further, in the projection of the respective first inclined side edge parts 36 and the respective second inclined side edge parts 46 in the thickness direction, top parts of the respective first contact point portions 56 and those of the respective second contact point portions 72 are shifted in position, and the respective first contact point portions 56 and the respective second contact point portions 72 partially overlap.

In a state where the male terminal 12 is not inserted yet (before the respective first contact point portions 56 are resiliently deformed), a separation distance between the top part of each first contact point portion 56 and that of each second contact point portion 72 is B (see FIG. 7) in the thickness direction of each inclined portion 22 in the male terminal 12 (i.e. in the thickness direction of each first inclined side edge part 36 and each second inclined side edge part 46). This separation distance B between the top part of each first contact point portion 56 and that of each second contact point portion 72 is smaller than the plate thickness of the male terminal 12 (B <A), whereby the male terminal 12 can be press-fit into the male terminal press-fit gap 16.

Note that each second contact point portion 72 is formed, for example, by press-working each second inclined side edge part 46 and, as shown in FIG. 4, a recess 74 open downward is formed at a position corresponding to each second contact point portion 72 in the outer surface (lower surface) of each second inclined side edge part 46.

### Assembly Process of Terminal Unit 10

Next, a specific example of an assembly procedure of the terminal unit 10 is described. Note that the assembly procedure of the terminal unit 10 is not limited to the one described below.

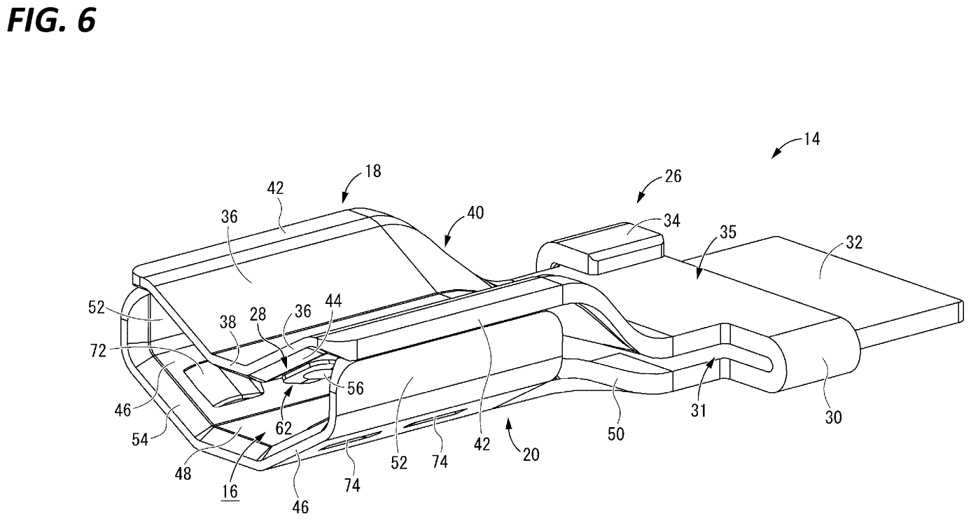

First, each contact point forming fitting 28 shown in FIG. 9 is formed by applying press working or the like to the thin metal plate. Thereafter, as shown in FIG. 8, the flat metal plate for constituting the female terminal body 26 is prepared in the developed state, and the welding fixing portion 58 of each contact point forming fitting 28 is overlapped on the inner surface of each first inclined side edge part 36 in the first contact portion 18 and fixed thereto by laser welding. Further, each contact point portion 72 is formed on each second inclined side edge part 46 by applying press working or the like to each second inclined side edge part 46 in the second contact portion 20. Then, the female terminal body 26 having each second contact point forming fitting 28 fixed thereto is bent into the shape described above to form the female terminal 14 shown in FIG. 6.

Subsequently, as shown in FIG. 7, the male terminal 12 bent into the shape described above and the female terminal 14 are brought closer to each other in the front-rear direction. The male terminal 12 is inserted into the male terminal press-fit gap 16 in the female terminal 14 from behind. At that time, since the separation distance B between the respective first contact point portions 56 and the second contact point portions 72 is smaller than the plate thickness A of the male terminal 12, the male terminal 12 is press-fit and inserted into the male terminal press-fit gap 16. Note that a separation distance between the first and second flat portions 38, 48 is sufficiently larger than the plate thickness A of the male terminal 12 (central flat portion 24) and the central flat portion 24 is inserted between these first and second flat portions 38, 48 in the vertical direction without contacting either one of the first and second flat portions 38, 48.

Thus, as also shown in FIGS. 4 and 5, the male terminal 12 is press-fit into the male terminal press-fit gap 16, whereby the respective first contact point portions 56 and the upper surfaces 22a of the respective inclined portions 22 contact each other and the respective second contact point portions 72 and lower surfaces 22b of the respective inclined portions 22 contact each other. Since each contact point forming fitting 28 is thin and easily resiliently deformed, each forward projecting tongue piece 60 and each rearward projecting tongue piece 62 are resiliently deformed in the direction to reduce the projecting dimension of the respective first contact point portions 56 into the male terminal press-fit gap 16 by press-fitting the male terminal 12 into the male terminal press-fit gap 16. In this way, the insertion (press-fitting) of the male terminal 12 into the male terminal press-fit gap 16 is allowed. The respective first contact point portions 56 are pressed against the upper surface 22a of each inclined portion 22 by the resilient restoration of each forward projecting tongue piece 60 and each rearward projecting tongue piece 62. Further, each inclined portion 22 biased downward by the respective first contact point portions 56 is pressed against the respective second contact point portions 72.

That is, with the male terminal 12 press-fit in the male terminal press-fit gap 16, the respective first contact point portions 56 are pressed into contact with the respective inclined portions 22 in the male terminal 12 and the inclined portions 22 in the male terminal 12 are respectively sandwiched between the respective first inclined side edge parts 36 and the respective second inclined side edge parts 46 in the female terminal 14 by resilient restoring forces of the respective first contact point portions 56. In the first embodiment, with the male terminal 12 press-fit in the male terminal press-fit gap 16, the respective inclined portions 22 are pressed into contact with the respective second contact point portions 72 by the resilient restoring forces of the respective first contact point portions 56, whereby the inclined portions 22 are respectively sandwiched between the respective first inclined side edge parts 36 and the respective second inclined side edge parts 46.

As a result, the male terminal 12 is press-fit into the male terminal press-fit gap 16 in the female terminal 14 and the male terminal 12 and the female terminal 14 are electrically connected, whereby the terminal unit 10 is completed.

In the terminal unit 10 in which the male terminal 12 and the female terminal 14 are connected, both a pressing force F1 (see FIG. 4) by the first contact point portion 56 and a pressing force F2 (reaction force against the pressing force exerted to each second contact point portion 72 from each inclined portion 22, see FIG. 4) by the second contact point portion 72 act in the same direction as the plate thickness direction in each inclined portion 22. Thus, each inclined portion 22 is stably sandwiched by the first and second contact point portions 56, 72, and the male terminal 12 and the female terminal 14 can be more reliably brought into a conductive state. Particularly, in the first embodiment, an action direction of the pressing force F1 by the first contact point portion 56 and that of the pressing force F2 by the second contact point portion 72 are not facing each other in the plate thickness direction of each inclined portion 22, specifically, the pressing force F1 by the first contact point portion 56 acts on both end parts in the lateral direction of each inclined portion 22, but the pressing force F2 by the second contact point portion 72 acts on a side laterally inward of a part where the pressing force F1 acts. In this way, it is avoided that the pressing forces F1, F2 from both upper and lower sides act at the same position in each inclined portion 22. As a result, the respective inclined portions 22 in the male terminal 12 press and expand gaps between the first and second contact point portions 56, 72 at a plurality of positions, wherefore insertion resistance can be reduced.

Further, as shown in FIG. 4, the pressing force F1 by the first contact point portion 56 acts as a downward component of force Fla and a laterally outward component of force F1b, and the pressing force F2 by the second contact point portion 72 acts as an upward component of force F2a and a laterally inward component of force F2b. Here, even if an external force is, for example, exerted to the male terminal 12 from one side to the other side (e.g. from right to left) in the lateral direction, a displacement of the male terminal 12 associated with the external force input by the component of force in an opposite direction (e.g. the component of force F1b acting from left to right) and the laterally inward component of force F2b is suppressed. Particularly, since the downward component of force Fla by the first contact point portion 56 and the upward component of force F2a by the second contact point portion 72 are facing each other in the vertical direction, a displacement of the male terminal 12 in the vertical direction is more reliably suppressed. As a result, a displacement of the male terminal 12 with respect to the female terminal 14 is suppressed and a conductive state of the male terminal 12 and the female terminal 14 can be stably maintained.

Particularly, these components of force F1, F2 are generated by a resilient restoring force of each first contact point portion 56, and the respective contact point forming fittings 28 including the respective first contact point portions 56 are provided on both left and right sides in the first contact portion 18. In this way, the pressing forces F1, F2 on the left side can be obtained by the left contact point forming fitting 28 (each first contact point portion 56), and the pressing forces F1, F2 on the right side can be obtained by the right contact point forming fitting 28 (each first contact point portion 56). As a result, it is also possible to separately set the magnitudes of the pressing forces F1, F2 on the left and right sides.

Further, in the terminal unit 10 of the first embodiment, the respective contact point forming fittings 28 thin and easily resiliently deformed are fixed to the respective first inclined side edge parts 36 constituting the male terminal press-fit gap 16, and the male terminal 12 is press-fit into the male terminal press-fit gap 16 while the respective first contact point portions 56 formed on the respective contact point forming fittings 28 are resiliently deformed. In this way, insertion resistance when the male terminal 12 is inserted into the male terminal press-fit gap 16 is reduced. Further, also when an external force is exerted to the male terminal 12 to swing the male terminal 12 in the vertical direction or when an external force is exerted to the male terminal 12 to rotate the male terminal 12 about a center axis extending in the front-rear direction, the respective first contact point portions 56 are deformed to follow a displacement of the male terminal 12, whereby a sandwiched state of the respective inclined portions 22 by the respective first and second contact point portions 56, 72 can be stably maintained. As a result, when an external force is exerted to the male terminal 12, a possibility of deteriorating an electrically connected state of the male terminal 12 and the female terminal 14 can be reduced.

Particularly, since the respective contact point forming fittings 28 for exerting the respective pressing forces F1, F2 to the respective inclined portions 22 are provided inside the male terminal press-fit gap 16, the enlargement of the female terminal 14 and, consequently, the terminal unit 10 can be avoided, for example, as compared to the case where spring members for exerting pressing forces F1, F2 to inclined portions are provided outside a male terminal press-fit gap.

In the female terminal 14, the respective separate contact point forming fittings 28 are fixed to form the respective first contact point portions 56 in the first contact portion 18, and the respective second contact point portions 72 are integrally formed on the second contact portion 20. Further, the external connecting portion 32 to be connected to an external wire or the like is provided in the front end part of the second contact portion 20. That is, the respective contact point forming fittings 28 and the female terminal body 26 can be made of different materials. The respective contact point forming fittings 28 can be made of an electrically conductive and springy material and the female terminal body 26 can be made of a material better in electrical conductivity. Since the respective second contact point portions 72 and the external connecting portion 32 are formed in the female terminal body 26 (second contact portion 20) better in electrical conductivity, an electrically conductive path from the external wire or the like to the male terminal 12 can be set to be short and electrically conductive performance is improved.

Each contact point forming fitting 28 includes the welding fixing portion 58 to be fixed to the first inclined side edge part 36 by welding. In this way, each contact point forming fitting 28 and each first inclined side edge part 36 can be fixed in a small space while an influence on electrically conductive performance is suppressed.

Particularly, each contact point forming fitting 28 includes the welding fixing portion 58 in the central part in the longitudinal direction (front-rear direction) and the forward projecting tongue piece 60 and the rearward projecting tongue piece 62 cantilevered toward the both end parts in the longitudinal direction from the welding fixing portion 58. In this way, even if the male terminal 12 press-fit into the male terminal press-fit gap 16 is displaced to swing in the vertical direction, both the forward projecting tongue piece 60 and the rearward projecting tongue piece 62 can be stably resiliently deformed and the respective first contact point portions 56 can be stably deformed to follow a displacement of the male terminal 12. Further, the respective first contact point portions 56 are provided in the intermediate parts in the longitudinal direction (front-rear direction) of the forward projecting tongue piece 60 and the rearward projecting tongue piece 62. In this way, even if the tip of the male terminal 12 is, for example, displaced to face upward or downward, i.e. even if the tip of the male terminal 12 is displaced to swing in either vertical direction, the first contact point portion 56 in each forward projecting tongue piece 60 and that in each rearward projecting tongue piece 62 can be stably brought into contact with the male terminal 12. Therefore, the state of the male terminal 12 sandwiched by the respective first contact point portions 56 and the respective second contact point portions 72 can be more stably maintained.

The male terminal 12 is provided with the pair of inclined portions 22, 22 and the central flat portion 24 between the respective inclined portions 22. Further, the female terminal 14 is provided with the pair of first inclined side edge parts 36, 36, the first flat portion 38 between the respective first inclined side edge parts 36, the pair of second inclined side edge parts 46, 46 and the second flat portion 48 between the respective second inclined side edge parts 46. In this way, each inclined portion 22 is sandwiched between each first inclined side edge part 36 and each second inclined side edge part 46 facing each other, wherefore a displacement associated with an external force in the lateral direction to the male terminal 12 can be effectively suppressed. Further, the male terminal 12 and the male terminal press-fit gap 16 are shaped to correspond to each other, whereby a possibility of increasing the insertion resistance of the male terminal 12 into the male terminal press-fit gap 16 can be reduced by avoiding contact with the male terminal 12 at positions other than the respective first contact point portions 56 and the respective second contact point portions 72 while the enlargement of the female terminal 14 is suppressed.

### Second Embodiment

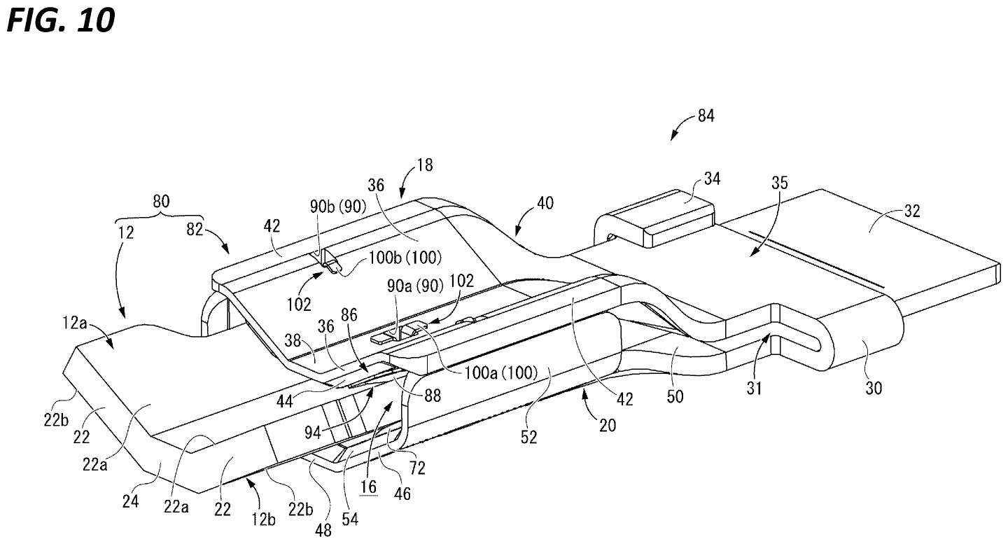

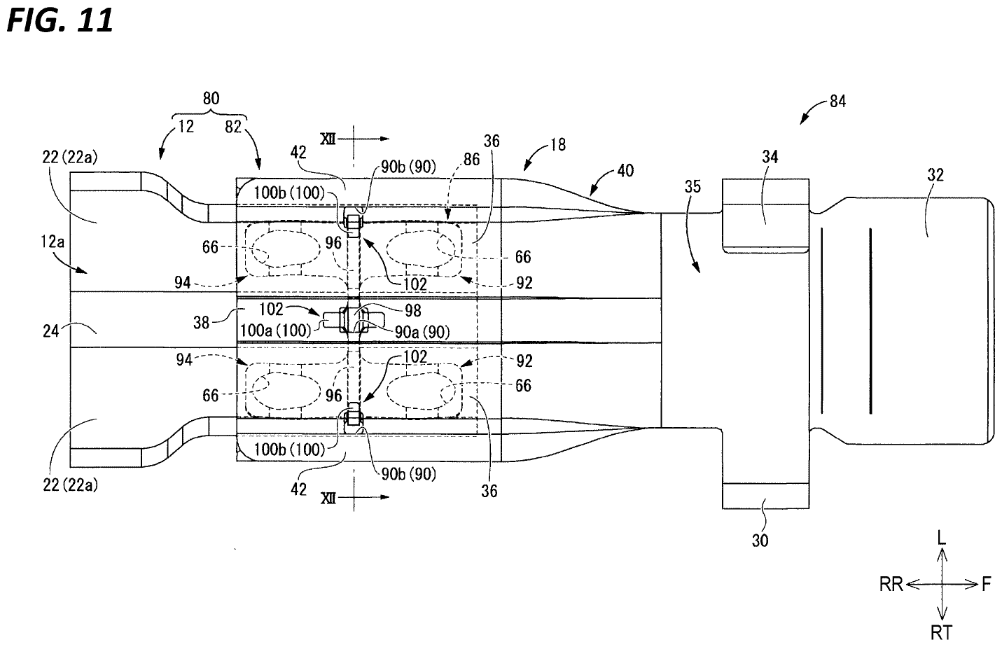

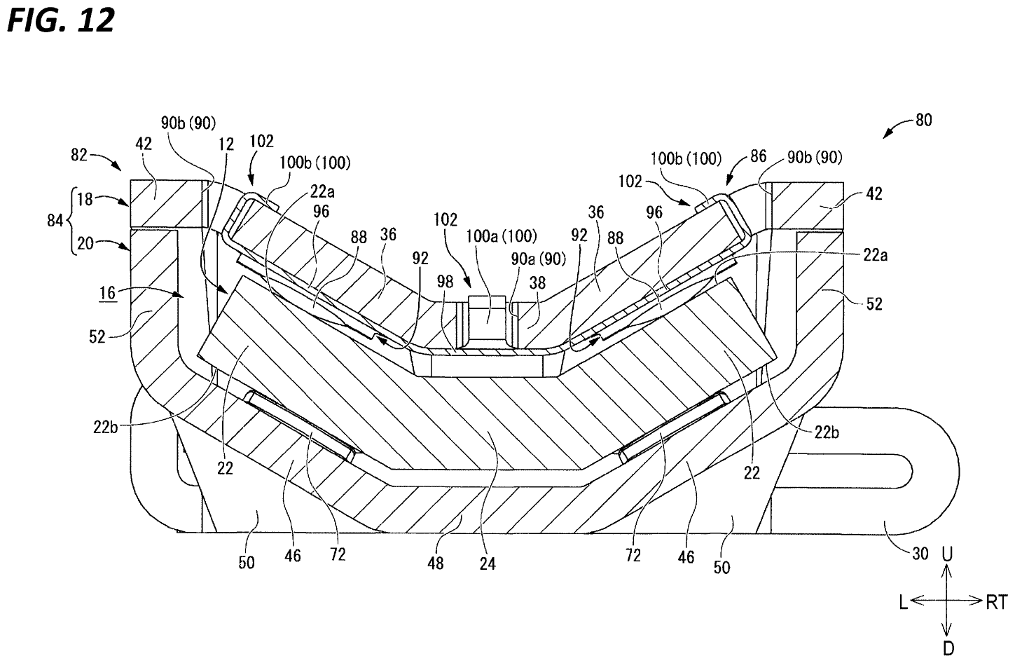

Next, a terminal unit 80 of a second embodiment of the present disclosure is described using FIGS. 10 to 14. Also in the second embodiment, a male terminal 12 shaped similarly to that of the first embodiment is adopted, and the terminal unit 80 is configured by press-fitting the male terminal 12 into a male terminal press-fit gap 16 in a female terminal 82. A basic structure of the female terminal 82 of the second embodiment is similar to that of the female terminal 14 of the first embodiment. However, the pair of contact point forming fittings 28, 28 are fixed to the female terminal body 26 by welding in the female terminal 14 of the first embodiment, whereas one contact point forming fitting 86 is fixed to a female terminal body 84 by crimping in the female terminal 82 of the second embodiment.

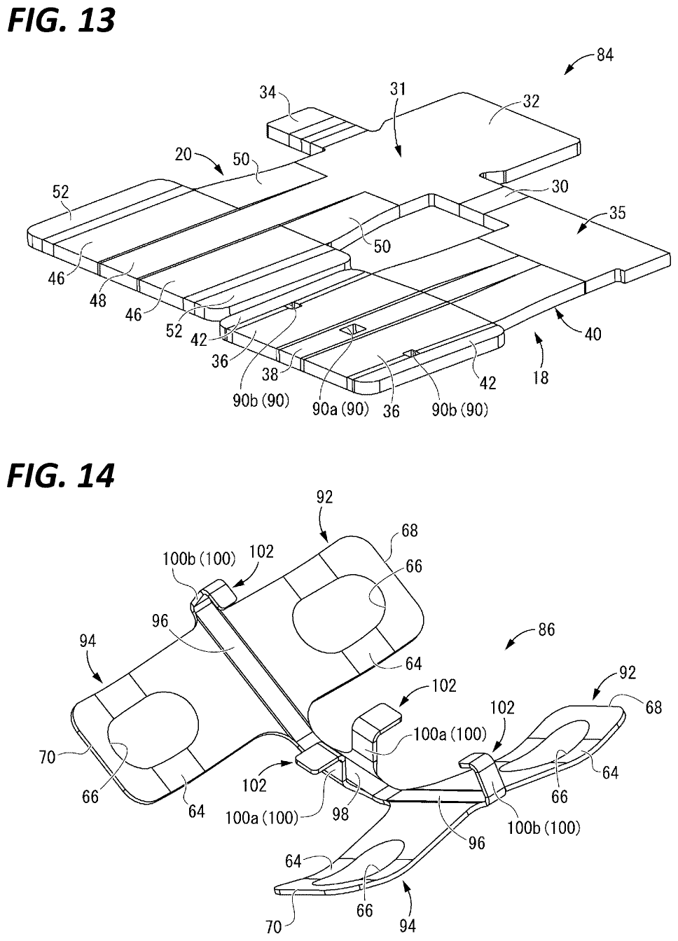

Note that the female terminal body 84 before being bent is shown in a developed state in FIG. 13. Further, in FIG. 14, the contact point forming fitting 86 is shown in a state fixed to the bent female terminal body 84 (female terminal body 84 is not shown) and in a state before the insertion of the male terminal 12 before the contact point forming fitting 86 (forward projecting tongue pieces 92 and rearward projecting tongue pieces 94 to be described later) is resiliently deformed. In the following description, points of difference between the female terminal 82 of the second embodiment and the female terminal 14 of the first embodiment are described, and substantially the same members and parts as those of the first embodiment are denoted by the same reference signs as in the first embodiment in figures and not described in detail.

### Female Terminal 82

Also in the female terminal 82 of the second embodiment, the contact point forming fitting 86 including first contact point portions 88 is fixed to a first contact portion 18. The contact point forming fitting 86 is fixed to the first contact portion 18 by crimping as described above, and through holes 90 for fixing the contact point forming fitting 86 are formed in central parts in the front-rear direction of a first flat portion 38 and first inclined side edge parts 36 in the first contact portion 18. As shown in FIG. 13, the respective through holes 90 have a substantially rectangular shape and are formed to penetrate through the first flat portion 38 and the respective first inclined side edge parts 36 in a plate thickness direction in the female terminal body 84 before being bent. In the second embodiment, the through hole 90a provided in the first flat portion 38 is provided in a central part in the lateral direction of the first flat portion 38, and the respective through holes 90b provided in the respective first inclined side edge parts 36 are provided in laterally outer end parts of the respective first inclined side edge parts 36.

Note that, also in the second embodiment, second inclined side edge parts 46 in a second contact portion 20 are provided with a pair of second contact point portions 72, 72 formed to partially project toward the male terminal press-fit gap 16 as in the first embodiment.

### Contact Point Forming Fitting 86

Although the respective contact point forming fittings 28 to be fixed to the respective first inclined side edge parts 36 are separately provided in the first embodiment, the contact point forming fitting 86 of the second embodiment has a structure obtained as if the respective contact point forming fittings 28 of the first embodiment were coupled in the lateral direction. That is, the contact point forming fitting 86 of the second embodiment includes a strip-shaped part extending in a press-fitting direction (front-rear direction) of the male terminal 12 into the male terminal press-fit gap 16 and includes the forward projecting tongue pieces 92 and the rearward projecting tongue pieces 94 respectively cantilevered toward both ends in the longitudinal direction from a central part in the longitudinal direction (front-rear direction). Each forward projecting tongue piece 92 and each rearward projecting tongue piece 94 are connected at a connecting portion 96 in a central part in the front-rear direction, and a pair of the connecting portions 96, 96 provided on both sides in the lateral direction are coupled by a coupling portion 98 in a center in the lateral direction. Note that, with the contact point forming fitting 86 fixed to the first contact portion 18, the coupling portion 98 extends in the lateral direction along the first flat portion 38 and the respective connecting portions 96 extend in a direction to be inclined upward toward laterally outer sides along the respective first inclined side edge parts 36. Therefore, with the contact point forming fitting 86 fixed to the first contact portion 18, the respective connecting portions 96 are bent upward with respect to the coupling portion 98.

Crimp fixing pieces 100 projecting upward, i.e. toward the first contact portion 18, are provided on the left end of the left connecting portion 96, the right end of the right connecting portion 96 and both front and rear sides of the coupling portion 98. When the contact point forming fitting 86 shaped in this way is fixed to the first contact portion 18, the respective crimp fitting pieces 100a provided on the both front and rear sides of the coupling portion 98 are inserted into the through hole 90a provided in the first flat portion 38 and projecting tip parts of the respective crimp fitting pieces 100a are bent outward in the front-rear direction, whereby a crimp fitting portion 102 is configured. Further, the respective crimp fitting pieces 100b provided on both left and right sides are inserted into the respective through holes 90b provided in the respective first inclined side edge parts 36 and projecting tip parts of the respective crimp fitting pieces 100b are bent inward in the lateral direction, whereby crimp fixing portions 102 are configured.

In short, in the contact point forming fitting 86, the crimp fixing portions 102 to be fixed to the first flat portion 38 and the respective first inclined side edge parts 36 in the first contact portion 18 by crimping are provided at three positions (lateral center part and both lateral end parts) in a central part in the front-rear direction. The respective forward projecting tongue pieces 92 on the both left and right sides and the respective rearward projecting tongue pieces 94 on the both left and right sides are respectively cantilevered forward and rearward from the central part in the front-rear direction where the crimp fixing portions 102 are provided. The respective forward projecting tongue pieces 92 and the respective rearward projecting tongue pieces 94 are respectively shaped similarly to the respective forward projecting tongue pieces 60 and the respective rearward projecting tongue pieces 62 in the first embodiment.

That is, each forward projecting tongue piece 92 and each rearward projecting tongue piece 94 are provided with the first contact point portions 88 extending in the longitudinal direction (front-rear direction) while having a curved shape convex toward the male terminal press-fit gap 16 in a side view and provided in intermediate parts in the front-rear direction of each forward projecting tongue piece 92 and each rearward projecting tongue piece 94. Specifically, each of the forward projecting tongue piece 92 and the rearward projecting tongue piece 94 have a curved shape convex toward a side separating from the first contact portion 18 and includes a bent portion 64 in an intermediate part in the front-rear direction. In each forward projecting tongue piece 92 and each rearward projecting tongue piece 94, the first contact point portion 88 is formed in a part extending over both sides in the front-rear direction and including the bent portion 64. A recess 66 is formed at a position corresponding to each first contact point portion 88 in a surface on a side opposite to a side where each first contact point portion 88 projects in each forward projecting tongue piece 92 and each rearward projecting tongue piece 94.

### Assembly Process of Terminal Unit 80

Next, a specific example of an assembly procedure of the terminal unit 80 is described. Note that the assembly procedure of the terminal unit 80 is not limited to the one described below.

First, the contact point forming fitting 86 is formed by applying press working or the like to a thin metal plate. Note that the respective connecting portions 96 are not bent with respect to the coupling portion 98 at this point of time, and the contact point forming fitting 86 is shaped as if the pair of contact point forming fittings 28, 28 shown in FIG. 8 described above were coupled by the coupling portion 98 in the central part in the front-rear direction. Further, the projecting tips of the respective crimp fitting pieces 100a, 100b are not bent and extend straight from the respective connecting portions 96 and the coupling portion 98.

Thereafter, the female terminal body 84 in the developed state shown in FIG. 13 is prepared, and the contact point forming fitting 86 is overlapped on the inner surface of the first contact portion 18. Then, the respective crimp fitting pieces 100a are inserted into the through hole 90a in the lateral center part and the projecting tip parts of the respective crimp fixing pieces 100a are bent outward in the front-rear direction to configure the crimp fitting portion 102. Further, the respective crimp fitting pieces 100b are inserted into the through holes 90b in the both lateral side parts and the projecting tip parts of the respective crimp fixing pieces 100b are bent inward in the lateral direction to configure the crimp fixing portions 102. In this way, the contact point forming fitting 86 is fixed to the first contact portion 18 by crimping.

Then, the female terminal body 84 having the contact point forming fitting 86 fixed thereto is bent into the shape described above to form the female terminal 82 of the second embodiment. At that time, the coupling portion 98 and the respective connecting portions 96 overlapped on the first flat portion 38 and the respective first inclined side edge parts 36 are bent together with the first flat portion 38 and the respective first inclined side edge parts 36, whereby the respective connecting portions 96 are bent with respect to the coupling portion 98. Note that the contact point forming fitting 86 may be mounted on the first contact portion 18 by forming the contact point forming fitting 86 in such a state that the respective connecting portions 96 are bent with respect to the coupling portion 98 as shown in FIG. 14 and crimping and fixing the contact point forming fitting 86 to the first contact portion 18 in such a state where the respective first inclined side edge parts 36 are bent with respect to the first flat portion 38.

By press-fitting the male terminal 12 into the male terminal press-fit gap 16 in the female terminal 82 formed in this way as in the first embodiment, the terminal unit 80 of the second embodiment is completed.

Since the contact point forming fitting fixed by welding in the first embodiment is fixed by crimping in the terminal unit 80 of the second embodiment, effects similar to those of the first embodiment can be exhibited. Particularly, since the contact point forming fitting 86 is fixed to the first contact portion 18 by crimping, the contact point forming fitting 86 can be easily fixed to the first contact portion 18 without requiring a device, a facility and the like necessary for welding.

### Modifications

Although the first and second embodiments have been described in detail as specific examples of the present disclosure, the present disclosure is not limited by this specific description. Modifications, improvements and the like within a range in which the aim of the present disclosure can be achieved are included in the present disclosure. For example, the following modifications of the embodiments are also included in the technical scope of the present disclosure.

(1) In the above embodiments, the angle of inclination θ1 of each inclined portion 22 to the central flat portion 24 in the male terminal 12, the angle of inclination θ2 of each first inclined side edge part 36 to the first flat portion 38 in the first contact portion 18 and the angle of inclination θ3 of each second inclined side edge part 46 to the second flat portion 48 in the second contact portion 20 are set to be substantially equal, and each inclined portion 22, each first inclined side edge part 36 and each second inclined side edge part 46 are substantially parallel. However, there is no limitation to this mode. For example, the angles of inclination θ2, θ3 may be different from the angle of inclination θ1. In that case, the formation positions, the shapes and the like of first contact point portions and second contact point portions may be so adjusted that projecting directions of the first and second contact point portions projecting from each first inclined side edge part and each second inclined side edge part are parallel to a plate thickness direction of each inclined portion in a male terminal.

(2) Although the male terminal 12, the first contact portion 18 and the second contact portion 20 respectively include the central flat portion 24, the first flat portion 38 and the second flat portion 48 in the above embodiments, at least one of a central flat portion, a first flat portion and a second flat portion may not be provided and a pair of inclined portions, a pair of first inclined side edge parts and a pair of second inclined side edge parts may be directly connected without via the central flat portion, the first flat portion and the second flat portion.

(3) The numbers, the shapes and the like of the first and second contact point portions are not limited to those described in the above embodiments. Although each first contact point portion 56, 88 and each second contact point portion 72 are shaped to have the front-rear dimension larger than the lateral dimension in the above embodiments, any of first and second contact point portions may have a hemispherical shape or one, three or more first/second contact point portions may be provided in a press-fitting direction of a male terminal on each of both sides in the lateral direction of a female terminal. Further, the number, the form and the like of the first contact point portions may be different from those of the second contact point portions or the first and second contact point portions may be provided at positions shifted from each other in the front-rear direction.

(4) Although the contact point forming fitting(s) 28, 28, 86 is/are fixed to the first contact portion 18 in the above embodiments, a contact point forming fitting may be fixed to at least one of first and second contact portions. The contact point forming fitting may be fixed to the second contact portion or may be fixed to both the first and second contact portions. Note that, in the case of fixing the contact point forming fittings to both the first and second contact portions, one may be, for example, fixed by welding and the other may be fixed by crimping. Further, even in the case of fixing the contact point forming fitting to one of the first and second contact portions, the contact point forming fitting may be fixed by a combination of welding and crimping.

(5) Although the respective first contact point portions 56, 88 are formed by striking the respective forward projecting tongue pieces 60, 92 and the respective rearward projecting tongue pieces 62, 94 in the above embodiments, there is no limitation to this mode and first contact point portions may be formed, for example, by cutting and raising. Further, although the welding fixing portion 58 is provided in the central part in the front-rear direction in each contact point forming fitting 28 in the first embodiment, welding fixing portions may be provided on both end parts in the front-rear direction. In that case, a first contact point portion may be, for example, provided by cutting and raising as described above in a central part in the front-rear direction of a contact point forming fitting.

(6) Although the contact point forming fitting 86 is shaped such that the parts to be fixed to the respective first inclined side edge parts 36 are coupled by the coupling portion 98 in the second embodiment, parts to be fixed to first inclined side edge parts may be separately provided as in the first embodiment without providing the coupling portion 98. In that case, crimp fixing pieces (crimp fixing portions) may be provided on both sides in the lateral direction of each contact point forming fitting or crimp fixing pieces (crimp fixing portions) may be provided in both end parts in the front-rear direction of each contact point forming fitting and a first contact point portion may be provided, such as by cutting and raising, in a central part in the front-rear direction.

(7) First and/or second contact portions may be provided with members or parts for preventing separation displacements (displacements in opening directions) of the first and second contact portions when a male terminal is press-fit into a male terminal press-fit gap. Such members or parts may be integrally provided to the first contact portion and/or the second contact portion or may be separately formed and assembled later.

### LIST OF REFERENCE NUMERALS

10 terminal unit (first embodiment)
12 male terminal
12a upper surface (of male terminal)
12b lower surface (of male terminal)
14 female terminal
16 male terminal press-fit gap
18 first contact portion
20 second contact portion
22 inclined portion
22a upper surface (of inclined portion)
22b lower surface (of inclined portion)
24 central flat portion
26 female terminal body
28 contact point forming fitting
30 coupling plate portion
31 front end part (of second contact portion)
32 external connecting portion
34 crimp piece
35 front end part (of first contact portion)
36 first inclined side edge part
38 first flat portion
40 transition portion
42 first end edge part
44 guiding surface
46 second inclined side edge part
48 second flat portion
50 transition portion
52 second end edge part
54 guiding surface
56 first contact point portion
58 welding fixing portion
60 forward projecting tongue piece
62 rearward projecting tongue piece
64 bent portion
66 recess
68 front end part
70 rear end part
72 second contact point portion
74 recess
80 terminal unit (second embodiment)
82 female terminal
84 female terminal body
86 contact point forming fitting
88 first contact point portion
90, 90a, 90b through hole
92 forward projecting tongue piece
94 rearward projecting tongue piece
96 connecting portion
98 coupling portion
100, 100a, 100b crimp fixing piece
102 crimp fixing portion

1. A terminal unit, comprising:
a plate-like male terminal; and
a female terminal to be connected to the male terminal,
the female terminal including a first contact portion and a second contact portion arranged to face each other across a male terminal press-fit gap, the male terminal being press-fit and arranged in the male terminal press-fit gap,
the male terminal including a pair of inclined portions inclined toward one side in a plate thickness direction of the male terminal on both sides in a plate width direction intersecting a press-fitting direction into the male terminal press-fit gap,
the first contact portion of the female terminal including a pair of first inclined side edge parts facing a surface of the male terminal on the one side in the plate thickness direction and respectively inclined along the pair of inclined portions of the male terminal and the second contact portion of the female terminal including a pair of second inclined side edge parts facing a surface of the male terminal on the other side in the plate thickness direction and respectively inclined along the pair of inclined portions of the male terminal,
a contact point forming fitting thinner than the first inclined side edge parts and the second inclined side edge parts and formed by an easily deflected and deformed and separate thin metal plate being conductively fixed to at least either the pair of first inclined side edge parts or the pair of second inclined side edge parts,
the contact point forming fitting including a pair of first contact point portions projecting toward the male terminal press-fit gap, and
the pair of first contact point portions being respectively pressed into contact with the pair of inclined portions of the male terminal and the pair of inclined portions of the male terminal being respectively sandwiched between the pair of first inclined side edge parts and the pair of second inclined side edge parts of the female terminal by resilient restoring forces of the pair of first contact point portions of the female terminal with the male terminal allowed to be press-fit into the male terminal press-fit gap by deflection and deformation of the pair of first contact point portions and the male terminal press-fit in the male terminal press-fit gap.

2. The terminal unit of claim 1, wherein:
the female terminal includes a coupling plate portion for conductively coupling the first and second contact portions and the second contact portion includes an external connecting portion,
the contact point forming fitting is fixed to the pair of first inclined side edge parts of the first contact portion of the female terminal,
a pair of second contact point portions formed by the respective second inclined side edge parts partially projecting toward the male terminal press-fit gap are provided on the pair of second inclined side edge parts of the second contact portion of the female terminal, and
the pair of inclined portions of the male terminal are pressed into contact with the pair of second contact point portions of the female terminal by resilient restoring forces of the first contact point portions with the male terminal press-fit in the male terminal press-fit gap.

3 . The terminal unit of claim 1, wherein the contact point forming fitting includes a welding fixing portion to be fixed to at least either the pair of first inclined side edge parts or the pair of second inclined side edge parts by welding.

4. The terminal unit of claim 3, wherein:
the contact point forming fitting of the female terminal has a strip shape extending in the press-fitting direction of the male terminal into the male terminal press-fit gap,
the contact point forming fitting includes the welding fixing portion provided in a central part in a longitudinal direction and a forward projecting tongue piece and a rearward projecting tongue piece cantilevered toward both ends in the longitudinal direction from the welding fixing portion, and
the forward projecting tongue piece and the rearward projecting tongue piece extend in the longitudinal direction while having a curved shape convex toward the male terminal press-fit gap in a side view and the first contact point portion is provided in an intermediate part in the longitudinal direction of each of the forward projecting tongue piece and the rearward projecting tongue piece.

5. The terminal unit of claim 1, wherein the contact point forming fitting includes a crimp fixing portion to be fixed to at least either the pair of first inclined side edge parts or the pair of second inclined side edge parts by crimping.

6. The terminal unit of claim 5, wherein:
the contact point forming fitting of the female terminal has a strip shape extending in the press-fitting direction of the male terminal into the male terminal press-fit gap,
the contact point forming fitting includes the crimp fixing portion provided in a central part in a longitudinal direction and a forward projecting tongue piece and a rearward projecting tongue piece cantilevered toward both ends in the longitudinal direction from the crimp fixing portion, and
the forward projecting tongue piece and the rearward projecting tongue piece extend in the longitudinal direction while having a curved shape convex toward the male terminal press-fit gap in a side view and the first contact point portion is provided in an intermediate part in the longitudinal direction of each of the forward projecting tongue piece and the rearward projecting tongue piece.

7. The terminal unit of claim 1, wherein:
the male terminal includes a central flat portion arranged between the pair of inclined portions in the plate width direction,
the first contact portion of the female terminal includes a first flat portion arranged between the pair of first inclined side edge parts in the plate width direction and spreading to face along the central flat portion of the male terminal, and
the second contact portion of the female terminal includes a second flat portion arranged between the pair of second inclined side edge parts in the plate width direction and spreading to face along the central flat portion of the male terminal.

8. A female terminal to be used in the terminal unit of claim 1.

9. A male terminal to be used in the terminal unit of claim 1.
